(19) United States
(12) Patent Application Publication
(10) Pub. No.: US 2024/0269894 A1
(43) Pub. Date: Aug. 15, 2024

(54) LARGE-SIZE SINGLE CRYSTAL CUTTING DEVICE AND METHOD OF THE SAME

(71) Applicant: TCL ZHONGHUAN RENEWABLE ENERGY TECHNOLOGY CO., LTD., Tianjin (CN)

(72) Inventors: Zhihui LIANG, Tianjin (CN); Jianhong XU, Tianjin (CN); Yujun XING, Tianjin (CN); Ruixiang ZHANG, Tianjin (CN); Wenjun KUANG, Tianjin (CN); Xinyue GUO, Tianjin (CN); Meng WANG, Tianjin (CN); Xuelong LIN, Tianjin (CN); Yiqiang GONG, Tianjin (CN); Xizhen LI, Tianjin (CN); Xiaopeng WANG, Tianjin (CN); Wei ZHAO, Tianjin (CN); Yanhui ZHAO, Tianjin (CN); Shun CHANG, Tianjin (CN); Yan SHI, Tianjin (CN); Zhijian LI, Tianjin (CN); Shusheng YANG, Tianjin (CN)

(73) Assignee: TCL ZHONGHUAN RENEWABLE ENERGY TECHNOLOGY CO., LTD., Tianjin (CN)

(21) Appl. No.: 18/007,480

(22) PCT Filed: Sep. 28, 2022
(86) PCT No.: PCT/CN2022/122324

§ 371 Date: Jan. 31, 2023

(30) Foreign Application Priority Data
Sep. 29, 2021 (CN) 202111155755.5

(51) Int. Cl. B28D 7/00; B28D 5/04

(52) U.S. Cl. CPC B28D 7/005; B28D 5/045

(57) ABSTRACT

The present application provides a large-sized single crystal cutting device and a method of using the same. The device includes a cutting system, a commutation system, and a detection system. The cutting system includes a cutting line, a pay-off axis, a guide wheel, and a take-up axis. The commutation system is disposed between the pay-off axis and the take-up axis to adjust a tension and a line speed of the cutting line. The detection system is configured to detect the tension and the line speed of the cutting line.

### CROSS-REFERENCE TO RELATED APPLICATION

This application claims priority of Chinese Patent Application No. 202111155755.5, filed on Sep. 29, 2021, the contents of which is incorporated herein by reference in its entirety.

### TECHNICAL FIELD

The present application relates to the field of photovoltaic technologies, and more particularly, to a large-size single crystal cutting device and a method of using the same.

### BACKGROUND

At present, since the diameter of the single crystal processed in the photovoltaic industry becomes larger, the cutting area of the single crystal in the corresponding cutting process also becomes larger. In order to better improve the processing capacity of the large-diameter single crystal, the processing limit speed of a device for processing the large-diameter single crystal is performed. By increasing the throughput of the device, the processing cost of the large-diameter single crystal is reduced, thereby obtaining advantages in competition with other competitors in the market.

When a conventional wire-cutting all-in-one machine is used to process the single crystal, the variation of the cutting ability of the conventional wire-cutting all-in-one machine is mainly dependent on the tension and the line speed of a cutting line when the cutting line and other auxiliary materials are unchanged. The greater the tension or line speed is, the stronger the cutting ability is, and vice versa.

The conventional wire-cutting all-in-one machine processes the single crystal in a transverse cutting manner, so that two tension arms for controlling the tension of the cutting line are provided at a pay-off end and a take-up end of the conventional wire-cutting all-in-one machine, respectively, so that the tension in the central portion of the cutting line cannot be ensured. Moreover, at present, the diameter of the single crystal is increased and its length is also increased, which causes a cross-sectional area of the single crystal to be increased during processing and the tension cannot be uniformly distributed at each cutting point. A current commutation system for the cutting line is a driven wheel, which can cause a lateral line speed to not be increased, thereby causing the processing efficiency of the conventional wire-cutting all-in-one machine to not meet the field production requirements.

### SUMMARY

The present application provides a large-size single crystal cutting device and a method of using the same. It can effectively solve following technical problems such as: a tension of a central portion of a cutting line cannot be ensured due to positions of two tension arms for controlling a tension of the cutting line respectively provided at a pay-off end and a take-up end of a conventional wire-cutting all-in-one machine, increasing of cross-sectional area of the single crystal in process and uniformly distributed tension at each cutting point due to increasing diameter and length of the single crystal at present, and processing efficiency of the conventional wire-cutting all-in-one machine not meeting the on-site production requirements due to a driven wheel is taking as a current commutation system for the cutting line to cause a lateral line speed not to be increased.

To solve the above technical problems, the present application provides a large-sized single crystal cutting device, including a cutting system, a commutation system, and a detection system, wherein the cutting system includes a cutting line, a pay-off axis, a guide wheel, and a take-up axis, the commutation system is disposed between the pay-off axis and the take-up axis to adjust a tension and a line speed of the cutting line, and the detection system is configured to detect the tension and the line speed of the cutting line.

Alternatively, in some embodiments of the present application, the commutation system includes a driving rotation axis configured to adjust the line speed or the tension of the cutting line.

Alternatively, in some embodiments of the present application, the driving rotation axis is disposed at a central position between the pay-off axis and the take-up axis.

Alternatively, in some embodiments of the present application, the commutation system includes a lifter configured to adjust a height of the driving rotation axis.

Alternatively, in some embodiments of the present application, the detection system includes a sensor disposed on the commutation system to detect the tension and the line speed of the cutting line.

Alternatively, in some embodiments of the present application, the lifter may move the driving rotation axis to adjust the tension and the line speed.

Alternatively, in some embodiments of the present application, the lifter may move the driving rotation axis in a vertical direction to adjust the tension and the line speed.

Alternatively, in some embodiments of the present application, the lifter may be configured to move the driving rotation axis in a vertical direction to change a tension of a central portion of the cutting line until the tension of the central portion coincides with a tension of end points of the pay-off axis and the take-up axis when the tension of the central portion of the cutting line does not coincide with the tension of the end points of the pay-off axis and the take-up axis.

Alternatively, in some embodiments of the present application, the lifter may be configured to move the driving rotation axis upwardly in a vertical direction to increase the tension of the central portion until the tension of the central portion coincides with the tension of the end points of the pay-off axis and the take-up axis when the tension of the central portion of the cutting line is less than the tension of the end points of the pay-off axis and the take-up axis.

Alternatively, in some embodiments of the present application, the lifter may be configured to move the driving rotation axis downwardly in a vertical direction to decrease the tension of the central portion until the tension of the central portion coincides with the tension of the end points of the pay-off axis and the take-up axis when the tension of the central portion of the cutting line is greater than the tension of the end points of the pay-off axis and the take-up axis.

The present application also provides a method of using the large-sized single crystal cutting device as described above, including:
disposing a single crystal in the large-sized signal crystal cutting device to cut the single crystal by driving the cutting line through the guide wheel;
adjusting a rotation speed of the commutation system to control the line speed of the cutting line to cooperate with rotation speeds of the pay-off axis and the take-up axis; and
detecting a tension of a central portion of the cutting line with the detection system to determine whether a detected tension of the central portion coincides with a tension of end points of the pay-off axis and the take-off axis or not,
when the detected tension of the central portion coincides with the tension of the end points of the pay-off axis and the take-off axis, continuing performing cutting; or
when the detected tension of the central portion of the cutting line does not coincide with the tension of the end points of the pay-off axis and the take-up axis, moving the commutation system in a vertical direction to change the tension of the central portion until the tension of the central portion coincides with the tension of the end points of the pay-off axis and the take-up axis, and then continuing performing cutting.

Alternatively, in some embodiments of the present application, the commutation system includes a driving rotation axis disposed at a central position of between the pay-off axis and the take-up axis to adjust a tension or a line speed of the central portion of the cutting line, and where the method further includes: when the line speed of the cutting line is lower, increasing rotation speeds of the driving rotation axis, the take-up axis, and the pay-off axis to increase a line speed of the cutting line; or when the line speed of the cutting line is higher, decreasing the rotation speeds of the driving rotation axis, the take-up axis, and the pay-off axis to decrease the line speed of the cutting line.

Alternatively, in some embodiments of the present application, the detection system includes a sensor disposed on the commutation system to detect the tension and the line speed of the cutting line, and where the method further includes: detecting the tension of the central portion of the cutting line with the sensor to determine whether the detected tension of the central portion coincides with the tension of the end points.

Alternatively, in some embodiments of the present application, the commutation system further includes a lifter disposed on the driving rotation axis to adjust the height of the driving rotation axis;
when the tension of the central portion is less than the tension of the end points, the lifter moves the driving rotation axis upwardly to increase the tension of the central portion; or,
when the tension of the central portion is greater than the tension of the end points, the lifter moves the driving rotation axis downwardly to decrease the tension of the central portion.

The present application employs the commutation system in place of the conventional intermediate axis driven system, so that the driving rotation axis has the ability to self-adjust the rotation speed. Therefore, the resistance in the cutting process of the cutting line is greatly reduced, thereby solving the technical problem that the conventional cutting process can only perform the subordinate rotation by the frictional force with the cutting line to increase the resistance of the cutting line and reduce the line speed of the cutting line, which causes the cutting force to be weak. The rotation speed of the driving rotation axis is self-adjusted to enable the rotation speed to be changed faster and more convenient, thereby solving the technical problem that the line speeds of the pay-off end and the take-up end may be larger and the friction resistance between the cutting line and the intermediate axis may be larger due to the increasing of the line speed in the prior art, which causes the linear speed of the cutting line to fail to be increased normally.

The present application detects and adjusts the tension of the cutting device by combining the commutation system with the detection system, where the commutation system is a driving rotation axis movable in the vertical direction, and the sensor can detect the tension of the cutting line on the driving rotation axis at any time, thereby solving the problems in the prior art that the tension cannot be adjusted, the tension in the cutting process cannot be lifted, and the tension of both ends of the pay-off end and the take-off end after the tension is forced to be lifted does not coincide with the tension of the central portion, which causes the short line and the cutting surface to be fluctuated greatly. When the tension of the central portion detected by the sensor is greater than the tension of the end points controlled by the tension arms at the both ends, the lifter moves the driving rotation axis downwardly to reduce the tension of the central portion, until the tension of the central portion is adjusted to coincide with the tension of the end points, and then the cutting is performed. When the tension of the central portion is less than the tension of the end points, the lifter moves the driving rotation axis upwardly to increase the tension of the central portion until the tension of the central portion is adjusted to coincide with the tension of the end points, and then the cutting is performed.

### BRIEF DESCRIPTION OF DRAWINGS

FIG. 1 is a structural schematic view of a large-sized single crystal cutting device according to an embodiment of the present application.

FIG. 2 is a flow chart of a method of using a large-sized single crystal cutting device according to an embodiment of the present application.

### REFERENCE SIGN ILLUSTRATION

1: Tension arm
2: Take-up axis
3: Pay-off axis
4: Single crystal
5: Guide wheel
6: Cutting line
7: Driven rotation axis
8: Sensor
9: Lifter

### EMBODIMENTS OF PRESENT DISCLOSURE

The present application is further described below with reference to the embodiments and the accompanying drawings.

In the description of the embodiments of the present application, it should be understood that orientations or position relationships indicated by the terms “top” and “bottom” are based on orientations or position relationships illustrated in the drawings. The terms are used to facilitate and simplify the description of the present application, rather than indicate or imply that the devices or elements referred to herein are required to have specific orientations or be constructed or operate in the specific orientations. Accordingly, the terms should not be construed as limiting the present application. In the description of the present application, it should be noted that the terms “disposed” and “connection” should be understood in a broad sense, unless otherwise clearly specified and defined. For example, it can be a fixed connection, a detachable connection, or integrated connection; it can be directly connected or indirectly connected through an intermediary, it can also be the connection between two elements. Those ordinary skilled in the art can understand the specific meanings of the above terms in the present application in specific situations.

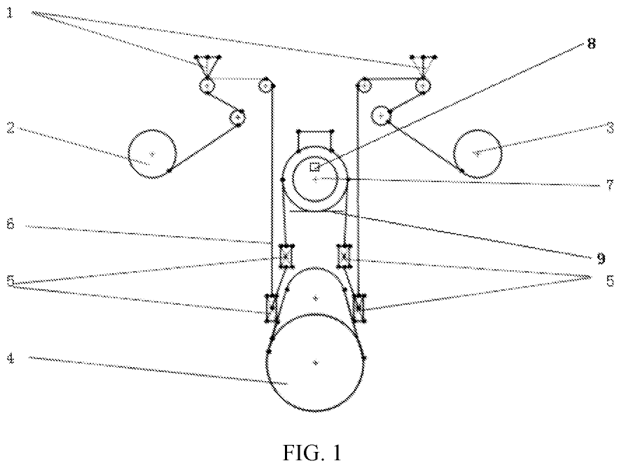

FIG. 1 is a structural schematic view of a large-sized single crystal cutting device according to an embodiment of the present application. As shown in FIG. 1, a large-sized single crystal cutting device includes a cutting system, a commutation system, and a detection system, where the cutting system includes a cutting line 6, a pay-off axis 3, a guide wheel 5, and a take-up axis 2, the commutation system is disposed between the pay-off axis 3 and the take-up axis 2 to adjust a tension and a line speed of the cutting line 6, and the detection system is configured to detect the tension and the line speed of the cutting line 6. Additionally, the cutting line 6 may be a rigid line, a sand line, or the like.

Additionally, the cutting device further include a tension arm 1. The take-up axis 2 is disposed on the left side of the cutting device, and the pay-off axis 3 is disposed on the right side of the cutting device. Six support wheels are disposed between the take-up axis 2 and the pay-off axis 3 for supporting the cutting line 6, where the six support wheels are divided into two groups, one of which is positioned adjacent to the take-up axis 2 and the other of which is positioned adjacent to the pay-off axis 3. Two tension arms 1 are disposed on the cutting line 6 between the two groups of support wheels to control the tension of the cutting lines 6 at both ends of the take-up axis 2 and the pay-off axis 3. The tension at the both ends of the take-up axis 2 and the pay-off axis 3 is compared with the tension detected by the sensor 8. When the tension at both ends of the take-up axis 2 and the pay-off axis 3 coincides with the tension detected by the sensor 8, the cutting is continued. When the tension at both ends of the take-up axis 2 and the pay-off axis 3 does not coincide with the tension detected by the sensor 8, the tensions need to be adjusted to coincide with each other, and then the cutting is performed.

The commutation system includes a driving rotation axis 7 for adjusting the line speed and the tension of the cutting line 6. The driving rotation axis 7 may have a general axis-like shape and be rotatably connected at a central position of the pay-off axis 3 and the take-up axis 2, preferably at a middle position of the pay-off axis 3 and the take-up axis 2. One end of the cutting line 6 is wound on the pay-off axis 3, and the other end is wound on the take-up axis 2, and the cutting line 6 is wound through the supporting wheels and the guide wheel 5 and tightly wound on the driving rotation axis 7. The driving rotation axis 7 can control its own rotation speed. When the rotation speed of the driving rotation axis 7 coincides with the line speed of the cutting line 6, the friction resistance between the cutting line 6 and the driving rotation axis 7 can be reduced, and the line speed of the cutting line 6 can be better adjusted, so that the lateral cutting force of the cutting device becomes larger and the cutting speed becomes faster.

The commutation system further includes a lifter 9. The lifter 9 is made of a steel material and has a rectangular shape. The length and width of the lifter are both greater than those of the driving rotation axis 7. The lifter 7 supports and moves the driving rotation axis 7. The driving rotation axis 7 is detachably connected to an upper surface of the lifter 9. The free rotation of the driving rotation axis 7 is not affected when the driving rotation axis 7 is mounted to the lifter 9. The lifter 9 can realize the free lifting of the driving rotation axis 7, and can control a lifting speed and a lifting distance, thereby achieving the purpose of adjusting the tension of the central portion of the cutting line 6 so that the tension of the cutting line 6 is uniform. The lifter 9 may be configured to adjust the height of the driving rotation axis 7. Furthermore, the lifter 9 can move the driving rotation axis 7 to adjust the tension and the line speed. Further, the lifter 9 moves the driving rotation axis 7 in a vertical direction to adjust the tension and the line speed.

Additionally, the lifter 9 may be configured to, when the tension of the central portion of the cutting line 6 does not coincide with the tension of end points of the pay-off axis 3 and the take-up axis 2, move the driving rotation axis 7 in a vertical direction to change the tension of the central portion until the tension of the central portion coincides with the tension of the end points of the pay-off axis 3 and the take-up axis 2.

Further, the lifter 9 may be configured to, when the tension of the central portion of the cutting line 6 is less than the tension of end points of the pay-off axis 3 and the take-up axis 2, move the driving rotation axis 7 upwardly in a vertical direction to increase the tension of the central portion until the tension of the central portion coincides with the tension of the end points of the pay-off axis 3 and the take-up axis 2.

Further, the lifter 9 may be configured to, when the tension of the central portion of the cutting line 6 is greater than the tension of end points of the pay-off axis 3 and the take-up axis 2, move the driving rotation axis 7 downwardly in a vertical direction to decrease the tension of the central portion until the tension of the central portion coincides with the tension of the end points of the pay-off axis 3 and the take-up axis 2.

The detection system includes a sensor 8 for detecting the tension and the linear speed of the cutting line 6. The sensor 8 may include, for example, a tension sensor and a line speed sensor. The sensor 8 is mounted on an outer surface of the driving rotation axis 7 with a bolt and detects the tension of the cutting line 6 in the central portion of the driving rotation axis 7 at any time. The detected tension is compared with the tension at the position of the tension arm 1, and the tension in the central portion is adjusted after the comparison. The tension in the central portion is adjusted by moving the driving rotation axis 7 in the vertical direction until the tension displayed by the sensor 8 is adjusted to coincide with the tension at the position of the tension arm 1. That is, the tension in the central portion coincides with the tension at the end point, and then the cutting is continued. Such tension adjustment makes it possible to achieve uniformity of tension, thereby solving the problem of large fluctuation of the cutting surface due to a non-uniform tension in the prior art.

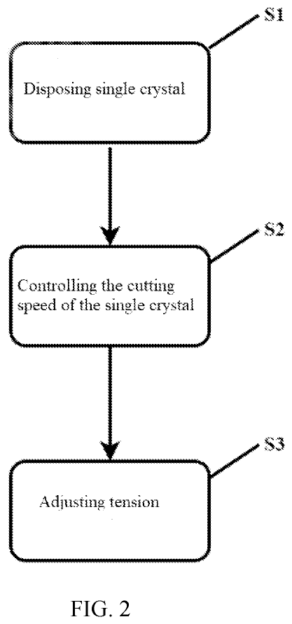

FIG. 2 is a flow chart of a method of using a large-sized single crystal cutting device according to an embodiment of the present application. As shown in FIG. 2, the method of using the large-sized single crystal cutting device includes the following steps S1-S3.

At S1, the single crystal is disposed in the cutting device to cut the single crystal by driving the cutting line through the guide wheel. Specifically, the single crystal 4 is disposed in the cutting device, and then the cutting line 6 is discharged from the pay-off axis 3, and wound through the supporting wheel, the guide wheel 5, and the driving rotation axis 7, and finally wound on the take-up axis 2. The rotation speed of the pay-off axis 3 coincides with the rotation speed of the take-up axis 2, and the line speed of the cutting at both ends of the cutting line 6 is controlled in paying off and taking up the line to cut the single crystal by driving the cutting line 6 through the guide wheel 5.

At S2, a cutting speed of the single crystal 4 is controlled, including: adjusting the rotation speed of the driving rotation axis 7 to adjust the rotation speed of the driving rotation axis 7 to coincide with the rotation speed of the take-up axis 2 and the pay-off axis 3; and controlling the line speed of the cutting line 6 to reduce a frictional force between the driving rotation axis 7 and the cutting line 6. Therefore, the line speed is increased greatly, and the cutting speed is fast, so the production efficiency is improved. When it is necessary to increase the cutting speed, the rotational speeds of the take-up axis 2, the pay-off axis 3, and the driving rotation axis 7 are increased simultaneously, where the rotational speeds of the take-up axis 2, the pay-off axis 3, and the driving rotation axis 7 need to be kept consistent, and the line speed of the cutting line 6 is controlled. When it is necessary to decrease the cutting speed, the rotational speeds of the take-up axis 2, the pay-off axis 3, and the driving rotation axis 7 are decreased simultaneously, where the rotational speeds of the take-up axis 2, the pay-off axis 3, and the driving rotation axis 7 need to be kept consistent, and the line speed of the cutting line 6 is controlled.

At S3, the tension is adjusted, including: detecting the tension of the cutting line 6 at the central portion of the driving rotation axis 7 with the sensor 8 to determine whether the detected tension of the central portion coincides with the tension of end points of the take-up axis 2 and the pay-off axis 3; continuing performing the cutting when the detected tension in the central portion coincides with the tension at the end points; and when the detected tension of the central portion does not coincide with the tension of the end points, changing the tension of the central portion by moving the driving rotation axis 7 in the vertical direction with the lifter 9 until the tension of the central portion coincides with the tension of the end points, and then the cutting is continued.

When the tension of the central portion is less than that of the end points, the lifter 9 is moved upwardly, and then the driving rotation axis 7 is moved upwardly, where a motion distance is determined according to a difference between the tension of the central portion and the tension of the end points, so that the tension of the central portion is increased until the tension of the central portion is adjusted to coincide with the tension of the end points, and then the cutting is continued. When the tension of the central portion is greater than the tension of the end points, the lifter 9 is moved downwardly, and then the driving rotation axis 7 is moved downwardly, where a motion distance is determined according to a difference between the tension of the central portion and the tension of the end points, so that the tension of the central portion is decreased until the tension of the central portion is adjusted to coincide with the tension of the end points, and then the cutting is continued. The magnitude of the fluctuation of the cutting surface of the single crystal depends on the uniform level of the tension of the cutting line 6. The more uniform the tension of the cutting line 6 is, the less the fluctuation of the cutting surface of the single crystal is, and the higher the production quality is. The more non-uniform the tension of the cutting line 6 is, the greater the fluctuation of the cutting surface of the single crystal is, and the lower the production quality is.

In another embodiment of the present application, the commutation system further includes a lifter 9 made of a high temperature resistant plastic and having a circular shape, where the diameter of the lifter 9 is greater than the length and width of the driving rotation axis 7. The lifter 9 moves the driving rotation axis 7. The driving rotation axis 7 is detachably connected to a lower surface of the lifter 9. When the driving rotation axis 7 is mounted to the lifter 9, the free rotation of the driving rotation axis 7 is not affected, and the lifter 9 can realize the free lifting of the driving rotation axis 7, and can control a lifting speed and a lifting distance, thereby achieving the purpose of adjusting the tension of the central portion of the cutting line 6 so that the tension of the cutting line 6 at various positions is uniform.

The embodiments of the present application have been described in detail above, but the description is only a preferred embodiment of the present application and should not be considered as limiting the scope of the present application. All equivalents and modifications made in accordance with the scope of the present application shall fall within the scope of the present application.

1. A large-sized single crystal cutting device, comprising: a cutting system, a commutation system, and a detection system, wherein the cutting system includes a cutting line, a pay-off axis, a guide wheel, and a take-up axis, the commutation system is disposed between the pay-off axis and the take-up axis to adjust a tension and a line speed of the cutting line, and the detection system is configured to detect the tension and the line speed of the cutting line.

2. The large-sized single crystal cutting device of claim 1, wherein the commutation system includes a driving rotation axis configured to adjust the line speed or the tension of the cutting line.

3. The large-sized single crystal cutting device of claim 2, wherein the commutation system further includes a lifter configured to adjust a height of the driving rotation axis.

4. The large-sized single crystal cutting device of claim 3, wherein the driving rotation axis is disposed at a central position between the pay-off axis and the take-up axis.

5. The large-sized single crystal cutting device of claim 1, wherein the detection system includes a sensor disposed on the commutation system to detect the tension and the line speed of the cutting line.

6. The large-sized single crystal cutting device of claim 4, wherein the lifter moves the driving rotation axis to adjust the tension and the line speed.

7. The large-sized single crystal cutting device of claim 4, wherein the lifter moves the driving rotation axis in a vertical direction to adjust the tension and the line speed.

8. The large-sized single crystal cutting device of claim 4, wherein the lifter is configured to move the driving rotation axis in a vertical direction to change a tension of a central portion of the cutting line until the tension of the central portion coincides with a tension of end points of the pay-off axis and the take-up axis when the tension of the central portion of the cutting line does not coincide with the tension of the end points of the pay-off axis and the take-up axis.

9. The large-sized single crystal cutting device of claim 8, wherein the lifter is configured to move the driving rotation axis upwardly in a vertical direction to increase the tension of the central portion until the tension of the central portion coincides with the tension of the end points of the pay-off axis and the take-up axis when the tension of the central portion is less than the tension of the end points of the pay-off axis and the take-up axis.

10. The large-sized single crystal cutting device of claim 8, wherein the lifter is configured to move the driving rotation axis downwardly in a vertical direction to decrease the tension of the central portion until the tension of the central portion coincides with the tension of the end points of the pay-off axis and the take-up axis when the tension of the central portion is greater than the tension of the end points of the pay-off axis and the take-up axis.

11. A method of using a large-sized single crystal cutting device, the large-sized single crystal cutting device comprising: a cutting system, a commutation system, and a detection system, wherein the cutting system includes a cutting line, a pay-off axis, a quid wheel, and a take-up axis, the commutation system is disposed between the pay-off axis and the take-up axis to adjust a tension and a line speed of the cutting line, and the detection system is configured to detect the tension and the line speed of the cutting line, wherein the method comprises:
disposing a single crystal in the large-sized single crystal cutting device to cut the single crystal by driving the cutting line through the guide wheel;
adjusting a rotation speed of the commutation system to control the line speed of the cutting line to cooperate with rotation speeds of the pay-off axis and the take-up axis; and
detecting a tension of a central portion of the cutting line with the detection system to determine whether a detected tension of the central portion coincides with a tension of end points of the pay-off axis and the take-off axis or not,
when the detected tension of the central portion coincides with the tension of the end points of the pay-off axis and the take-off axis, continuing performing cutting; or
when the detected tension of the central portion of the cutting line does not coincide with the tension of the end points of the pay-off axis and the take-up axis, moving the commutation system in a vertical direction to change the tension of the central portion until the tension of the central portion coincides with the tension of the end points of the pay-off axis and the take-up axis, and then continuing performing cutting.

12. The method of using the large-sized single crystal cutting device according to claim 11, wherein the commutation system includes a driving rotation axis disposed at a middle position between the pay-off axis and the take-up axis to adjust a line speed or a tension of the central portion of the cutting line, and the method further includes:
when the line speed of the cutting line is lower, increasing rotation speeds of the driving rotation axis, the pay-off axis, and the take-up axis to increase the line speed of the cutting line; or
when the line speed of the cutting line is higher, decreasing the rotation speeds of the driving rotation axis, the pay-off axis, and the take-up axis to decrease the line speed of the cutting line.

13. The method of using the large-sized single crystal cutting device according to claim 11, wherein the detection system includes a sensor disposed on the commutation system to detect the tension and the line speed of the cutting line, and the method further includes: detecting the tension of the central portion of the cutting line with the sensor to determine whether the detected tension of the central portion coincides with the tension of the end points.

14. The method of using the large-sized single crystal cutting device according to claim 13, wherein the commutation system further includes a lifter disposed on the driving rotation axis to adjust a height of the driving rotation axis;
when the tension of the central portion is less than the tension of the end points, the lifter moves the driving rotation axis upwardly to increase the tension of the central portion; or
when the tension of the central portion is greater than the tension of the end points, the lifter moves the driving rotation axis downwardly to decrease the tension of the central portion.

15. The method of using the large-sized single crystal cutting device according to claim 12, wherein the detection system includes a sensor disposed on the commutation system to detect the tension and the line speed of the cutting line, and the method further includes: detecting the tension of the central portion of the cutting line with the sensor to determine whether the detected tension of the central portion coincides with the tension of the end points.

16. The method of using the large-sized single crystal cutting device according to claim 15, wherein the commutation system further includes a lifter disposed on the driving rotation axis to adjust a height of the driving rotation axis;
when the tension of the central portion is less than the tension of the end points, the lifter moves the driving rotation axis upwardly to increase the tension of the central portion; or
when the tension of the central portion is greater than the tension of the end points, the lifter moves the driving rotation axis downwardly to decrease the tension of the central portion.
